(19) United States
(12) Patent Application Publication
(10) Pub. No.: US 2024/0377592 A1
(43) Pub. Date: Nov. 14, 2024

(54) PORT DENSITY BULKHEAD AND CONNECTORS

(71) Applicant: Rakuten Symphony UK Ltd, Surrey (GB)

(72) Inventors: Gerard MacManus, Surrey (GB); Richard NASH, Surrey (GB)

(73) Assignee: Rakuten Symphony UK Ltd, Surrey (GB)

(21) Appl. No.: 18/033,404

(22) PCT Filed: Nov. 22, 2022
(86) PCT No.: PCT/US22/50780

§ 371 Date: Apr. 24, 2023

(51) Int. Cl. G02B 6/38; G02B 6/44

(52) U.S. Cl. CPC G02B 6/3879; G02B 6/3825; G02B 6/44715; G02B 6/44775

(57) ABSTRACT

A connector is provided having a housing having a first end and a second end, the first end having a face and the second end being substantially open. The first end of the housing has an opening in it. The connector also has a gasket at the second end. The connector also has conduits extending from the opening of the first end to the second end. The conduits enter the housing at the first end as a single cable, and separate from each other within the housing. Also provided is a connector system including the connector, a receiving connector mounted on a circuit board, and an outdoor unit housing the circuit board having an opening for receiving the conduits.

### FIELD OF THE INVENTION

The invention relates to connectors for providing waterproof connections to a distributed unit (DU) outdoor unit for a radio system. In particular, the invention relates to waterproof connectors for connecting multiple radio unit (RU) type equipment to the outdoor unit by way of, for example, fiber optic cables.

### BACKGROUND

Port density in the context of this disclosure refers to an input/output panel that a user interacts with in order to connect various parts of a network. In particular, this disclosure relates to an input/output (IO) panel in a distributed unit (DU) outdoor unit that is in turn connected to multiple radio unit (RU) type equipment.

Typically, such units may connected by fiber optic cables. Each fiber optic port is then distributed such that each individual port can be waterproofed independently. This allows for waterproof connections, such as connections in accordance with IP65 standards. Such individual ports are shown on a circuit board in FIG. 1. Bulkheads, or pass through connectors, may then be provided to support waterproofing of the distributed connections. Such bulkheads, providing individual connections, are available off the shelf from specialist connector manufacturers.

In modern outdoor units, IO panels are becoming more dense as product requirements for interconnects increase. Such increasing connection requirements will necessarily lead to wider products, and resulting size requirements will be too large for existing equipment, and will be larger than what is reasonable to expect at a product design level. As shown in FIG. 2, individual ports typically require corresponding individual bulkheads and waterproof connectors, thereby requiring that the ports be sufficiently spaced apart in a surface of the outdoor unit.

There is a need for a connector and a corresponding connector system that can combine multiple waterproof connections so as to minimize space while retaining required protections against harsh environments. Accordingly, there is a need for a pass-through connector that can house multiple connections within a single bulkhead.

The outdoor unit may therefore require reconfiguring to receive multiple connections within a single bulkhead. There is a need for such units that can fit in standard rack cabinets while increasing the number of connections contained therein.

### SUMMARY

In some embodiments, a connector is provided having a housing having a first end and a second end, the first end having a face and the second end being substantially open. The first end of the housing has an opening in it. The connector also has a gasket at the second end.

The connector also has a plurality of conduits extending from the opening of the first end to the second end. The plurality of conduits enter the housing at the first end as a single cable, and separate from each other within the housing.

In some embodiments, the connector also includes a cable gland sealing the single cable to the opening.

In some embodiments, the connector also includes a flange at the second end. The gasket is then compressed against a surface of an outdoor unit by way of the flange. In some such embodiments, the connector includes at least one screw for fixing the flange to the surface of the outdoor unit.

In some embodiments, the plurality of conduits individually connect to a corresponding receiving connector of an outdoor unit. In some such embodiments, upon connecting each of the conduits to the corresponding receiving connector of the outdoor unit, the housing is movable along the single cable by sliding the single cable through the opening. The connector further includes a cable gland for fixing the housing relative to the single cable, thereby compressing the gasket between the housing and a surface of the outdoor unit.

In some embodiments, each conduit of the plurality of conduits is a fiber optic fiber or cable. In some such embodiments, each fiber optic fiber ends in a fiber optic connector. In some such embodiments, each of the plurality of conduits individually connects to a corresponding receiving connector of an outdoor unit, and each corresponding receiving connector is a female connector that receives the corresponding fiber optic connector.

In some embodiments, the housing further comprises an opening in a surface extending from the first end to the second end. The opening is then sealable with a lid. In some such embodiments, the opening or the lid is gasketed, such that a gasket seals the lid to the opening during use.

In some embodiments, the housing is at least partially tapered, such that the first end is smaller than the second end.

In some embodiments, the connector further includes internal structures for separating the plurality of conduits between the first end and the second end, such that the internal structures locate each of the plurality of conduits.

Also provided is a connector system including a first connector having a housing having a first end and a second end, the first end having a face and the second end being substantially open. The face of the first end has an opening in it.

The system includes a receiving connector mounted on a circuit board for receiving a plurality of conduits located within the first connector. The system also includes an outdoor unit housing the circuit board and having an opening for receiving the plurality of conduits.

The first connector then has a gasket at the second end for sealing the first connector against the outdoor unit housing around the opening, and the plurality of conduits enter the housing at the first end as a single cable and separates into the plurality of conduits within the housing.

In some such systems, the receiving connector includes a plurality of independent receiving ports, each receiving port configured for receiving a single conduit of the plurality of conduits. In some such embodiments, each of the plurality of condutis is a fiber optic fiber terminating in a fiber optic connector.

In some embodiments, the system further includes a cable gland for sealing the single cable to the opening, such that when the plurality of conduits are received by the plurality of independent receiving ports, the cable gland fixes a location of the housing such that pressure is applied to the gasket against the outdoor unit housing.

In some embodiments, the housing further includes an opening in a surface extending from the first end to the second end. The opening is sealable with a lid.

In some embodiments, the housing of the connector is at least partially tapered, such that the first end is smaller than the second end.

### BRIEF DESCRIPTION OF THE DRAWINGS

FIG. 1 is circuit board having individual ports for receiving fiber optic conduits.

FIG. 2 is an IO panel layout associated with a circuit board having individual ports.

FIG. 3 is a perspective view of a connector in accordance with this disclosure.

FIG. 4 is a top view of a connector in accordance with this disclosure.

FIG. 5 is a side view of a connector in accordance with this disclosure.

FIG. 6 is a partially exploded view of a connector in accordance with this disclosure.

FIG. 7 is a system in accordance with this disclosure.

FIG. 8 is a partially exploded system in accordance with this disclosure.

FIG. 9 is a circuit board for use in an outdoor unit in accordance with this disclosure.

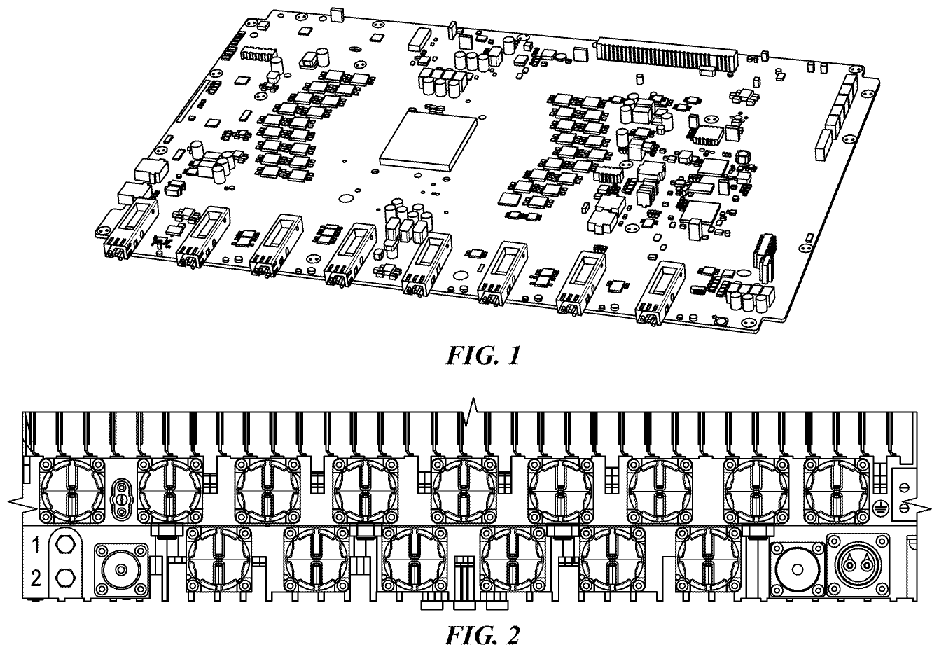

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

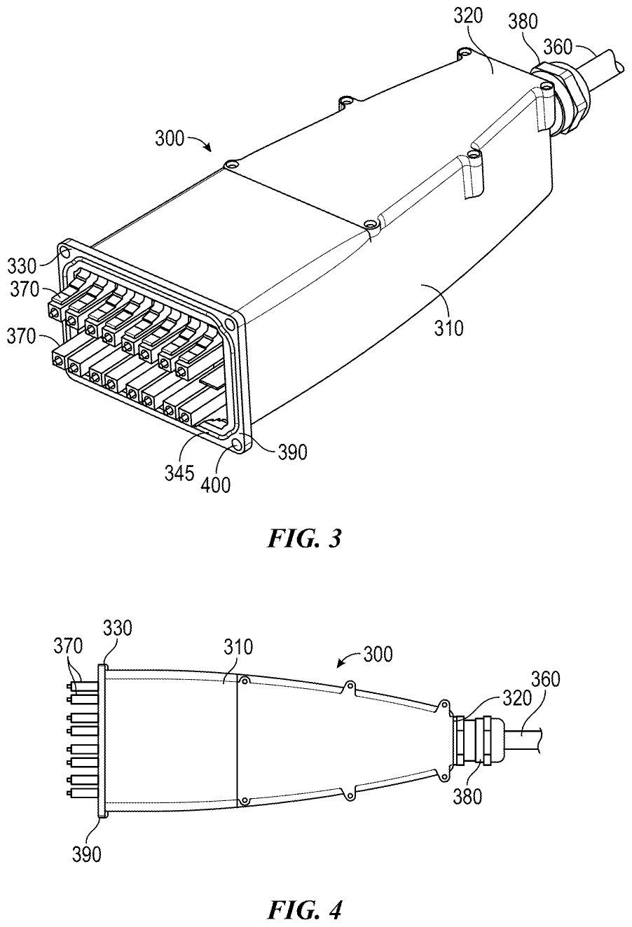

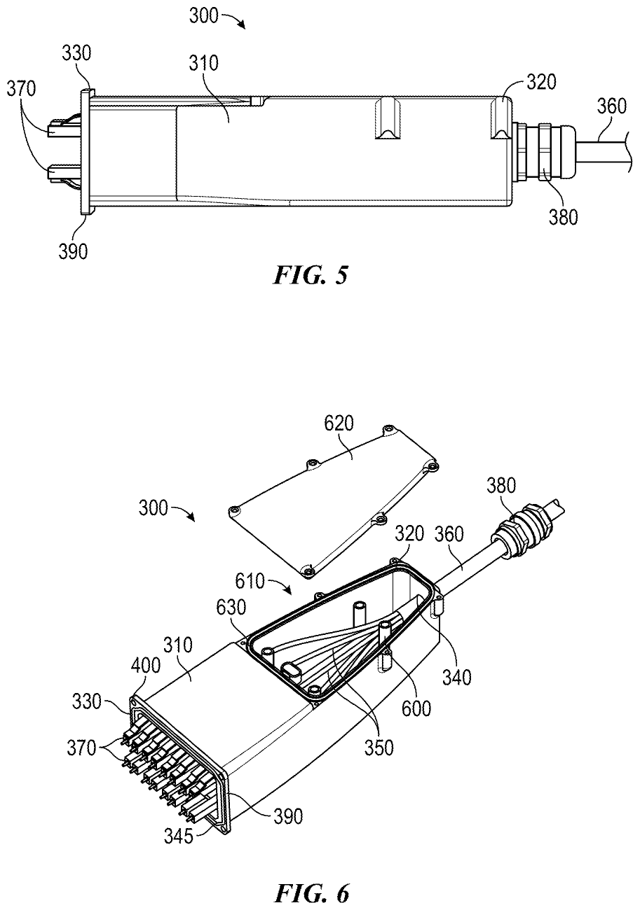

FIG. 3 is a perspective view of a connector 300 in accordance with this disclosure. FIG. 4 is a top view of the connector 300 of FIG. 3. FIG. 5 is a side view of the connector 300 of FIG. 3. FIG. 6 is a partially exploded view of the connector 300 of FIG. 3.

As shown, the connector 300 includes a housing 310 having a first end 320 and a second end 330. The first end 320 has a face with an opening 340 in it while the second end 330 is typically substantially open. The second end 330 is typically provided with a gasket 345 which can be used to seal the housing 310 against a surface or against a port or port adapter in a surface.

Within the housing 310, a plurality of conduits 350 extend from the opening 340 to the second end 330 of the connector 300. The connector 300 typically transmit signals by way of the conduits 350, and the conduits enter the housing 310 at the first end 320 as a single cable 360 and separate from each other within the housing.

The conduits 350 are typically fiber optic fibers or other fiber optic conduits, and the cable 360 is a fiber optic cable. Because the connector 300 described is typically used outdoors, the cable 360 is typically an outdoor cable, and may be provided with associated strength members, jackets, and armoring layers.

Within the housing 310, the cable 360 may be broken down into individual conduits 350, each of which connects to a different receiving connector located at a port of the outdoor unit. Accordingly, each of the plurality of conduits 360 may individually connect to a corresponding receiving connector of an outdoor unit, described in more detail below.

Each conduit 350 is typically a single fiber optic fiber or a single grouping of fiber optic fibers, that connects to a single receiving connector. Accordingly, each conduit 350 may terminate in a fiber optic connector 370. Such a connector 370 may be a standard connector type, such as a standard connector (SC) or a lucent connector (LC) 370. The embodiments in the figures are shown with LC connections 370, but other connector types are contemplated as well. The fibers of the conduit 350 typically terminate in a male connector which then mates with a female receiving connector.

As shown, the connector 300 also includes a cable gland 380 which seals the single cable 360 to the opening 340. The cable gland 380, also referred to as a cord grip or cable fitting, grips the cable 360 and fixes its location relative to the housing 310. As such, the cable gland 380 may be located at the opening 340 during use, and may form a watertight seal, such that the housing 310 is waterproof.

When each of the conduits 350 connects to a corresponding receiving connector, the housing 310 remains movable along the single cable 360 by sliding the single cable through the opening 340. As such, once connected, the cable gland 380 may be applied to the cable 360 adjacent the opening 340 in order to fix the housing 310 relative to the single cable. The cable gland 380 thereby compresses the gasket 345 between the housing 310 and a surface of the outdoor unit.

The connector 300 may have a flange 390 at the second end 330. The flange 390 may then support or cover the gasket 345, and the gasket may then be compressed against a surface of an outdoor unit to which the connector 300 is fixed by way of the flange. For example, the flange 390 may be provided with a screw hole 400, and the flange may then be fixed to a surface of the outdoor unit by a screw.

As shown, the housing 310 may be at least partially tapered, such that the first end 320 is smaller than the second end. As such, the cable 360 enters the housing 310 at a smaller first end 320, and the conduits 350 then spread out within the housing 310. The second end 330 is then provided with additional space for individual fiber optic connectors, such as LC connectors 370.

In some embodiments, as shown in FIG. 6, internal structures 600, such as posts, are provided for separating the plurality of conduits 350 within the housing 310 between the first end 320 and the second end 330. The internal structures 600 then locate each of the plurality of conduits 350 such that they are spread out and directed as needed.

The housing 310 may further comprise an opening 610 in a surface 420 extending from the first end 320 to the second end 330. The opening 610 may be sealable with a lid 620. As shown, one of the opening 610 or the lid 620 may be provided with a gasket 630, such that the gasket seals the lid to the opening during use. The lid 620 may be fixed to the housing 310 by screws, for example.

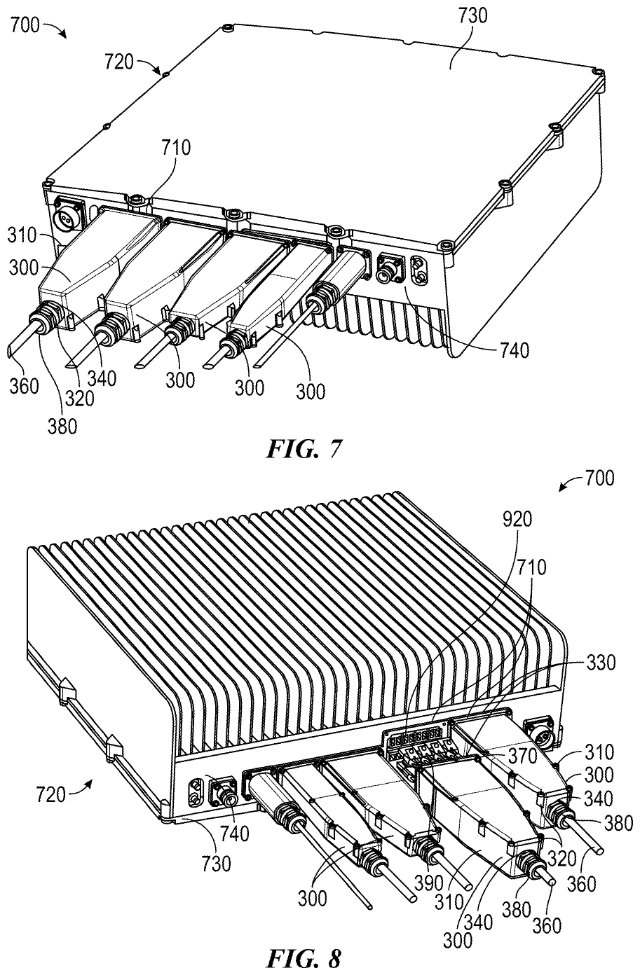

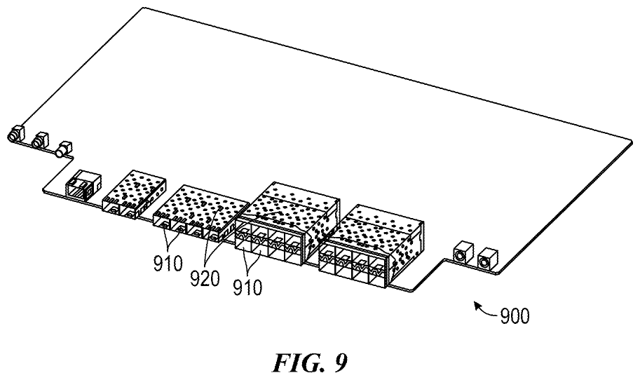

FIG. 7 is a system 700 in accordance with this disclosure including the connector 300 of FIG. 3. FIG. 8 is a partially exploded system 700 in accordance with this disclosure. FIG. 9 is a circuit board 900 for use in an outdoor unit in accordance with this disclosure.

As shown, the system 700 includes at least one connector 300, and in some cases multiple connectors, such as those discussed above with respect to FIG. 3. The connectors 300 each have a housing 310 with a first end 320 and a second end 330. The first end 320 has a face has an opening in it 340 and the second end 330 is substantially open.

The connectors 300 then transmit signals to corresponding openings, or ports 710 in an outdoor unit 720. Individual receiving ports 910 incorporated into receiving connectors 920 are mounted on the circuit board 900, and thereby receive a plurality of conduits 350 located within each of the connectors 300.

When the outdoor unit 720 is assembled, the circuit board 900 is installed within a housing 730 of the outdoor unit. The ports 710 are then located within one or more surfaces 740 of the housing 730. The receiving connectors 920 are then located adjacent the ports 710. As such, individual conduits 350 terminating in fiber optic connectors 370 can interface with individual receiving ports 910 at corresponding ports 710 of the outdoor unit 720.

As noted above, the second end 330 of the connector 300 is typically provided with a gasket 345 which can be used to seal the housing 310 against the surface 740 or against a port 710 or port adapter in the surface. Accordingly, where the port 710 is simply an opening in a surface of the housing 730, the gasket may seal against the surface of the housing. However, a designated port adapter may be provided in order to enhance the seal of the gasket 345, and the gasket, along with a flange 390 containing the gasket, may be shaped to mate with the port adapter.

Within the housing 310, the plurality of individual conduits 350 extend from the opening 340 in the first end 320 to the second end 330 of the connector 300. The connector 300 typically transmit signals by way of the conduits 350, and the conduits enter the housing 310 at the first end 320 as a single cable 360 and separate from each other within the housing. The second end is then sealed against the surface 740 of the outdoor unit 720 at a corresponding port 10, and each individual conduit 350 connects with a corresponding individual receiving port 910 by way of a fiber optic connector 370.

In this way, the gasket 340 seals the second end 330 of the connector 300 against the housing 730 of the outdoor unit 720. Similarly, the cable 360 is sealed at the opening 340 of the first end 320 of the connector 300. As discussed above, this may be by way of a cable gland 380. In this way, the connector system 700 may form a sealed assembly to connect multiple individual fiber optic conduits 350 to receiving ports 710 within a single bulkhead, or connector 300, thereby drastically increasing the density of connections possible within an outdoor unit 720 of a given size. Such a sealed assembly 700 may provide weatherproofing for all connections contained therein. Accordingly, the assembly 700 may meet required weatherproofing standards, such as IP65 while providing multiple connectors in a single port.

Typically, the individual receiving connectors 920 may each include a plurality of individual receiving ports 910, with each receiving port being configured for receiving a single conduit 350 of the plurality of conduits of the connector 300. Accordingly, the fiber optic connector 370 of each single conduit 350 mates with the corresponding port 910 of the circuit board 900 in the housing 730 of the outdoor unit 720.

The cable gland 380 may seal the single cable 360 to the opening in the first end 320. When the plurality of conduits 350 are received by the plurality of individual receiving ports 910, the fiber optic connectors 370 may be locked in place within the ports. Further, the cable gland 380 may then fix a location of the housing 310 such that pressure is applied to the gasket 345 against the outdoor unit housing 730, thereby enhancing the seal of the assembly 700. Accordingly, prior to locating the cable gland 380, the housing 310 of the connector 300 may be movable along the single cable 360 by sliding the single cable through the opening 340. The cable gland 380 may then fix the housing 310 along the cable 360.

As shown, the gasket 345 may be provided on a flange 390, thereby providing a surface that can be compressed against the outdoor unit housing 730. The flange 390 may be fixed against the housing 730 in various ways. Accordingly, a receiving clamp may be provided in the outdoor unit 720 for mating with the flange 390, or screws may be provided in the flange 390 for mating with threaded holes in the housing 730.

In the system 700 described herein, the housing 730 of the outdoor unit 720 still contains an IO panel with a variety of ports 710. However, each such port 710 may provide access to a large number of receiving ports 910 mounted on a circuit board 900, instead of each such connection traditionally requiring a single port. The approach described herein is easily customizable. As shown in FIG. 9, each port 710 may provide access to a receiving connector 920 with a different number of receiving ports 910. The number of receiving ports may thereby be customized and scaled to a particular circuit board design.

Further, because the cables are easily customizable, such a connector 300 or bulkhead can be assembled on site from a set of parts. Accordingly, a vendor could be issued with lids 620, housings 310 of different sizes, various gaskets 345, 630, and cable glands 380 and assemble to the desired length at the time of installation.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A connector comprising:
a housing having a first end and a second end, the first end having a face and the second end being substantially open, wherein the face of the first end has an opening in it;
a gasket at the second end;
a plurality of conduits extending from the opening of the first end to the second end, wherein the plurality of conduits enter the housing at the first end as a single cable, and separate from each other within the housing.

2. The connector of claim 1 further comprising a cable gland sealing the single cable to the opening.

3. The connector of claim 1 further comprising a flange at the second end, and wherein the gasket is compressed against a surface of an outdoor unit by way of the flange.

4. The connector of claim 3 further comprising at least one screw for fixing the flange to the surface of the outdoor unit.

5. The connector of claim 1, wherein each of the plurality of conduits individually connects to a corresponding receiving connector of an outdoor unit.

6. The connector of claim 5, wherein upon connecting each of the plurality of conduits to the corresponding receiving connector of the outdoor unit, the housing is movable along the single cable by sliding the single cable through the opening, and wherein the connector further comprises a cable gland for fixing the housing relative to the single cable and thereby compressing the gasket between the housing and a surface of the outdoor unit.

7. The connector of claim 1, wherein each conduit of the plurality of conduits is a fiber optic fiber.

8. The connector of claim 7, wherein each fiber optic fiber ends in a fiber optic connector.

9. The connector of claim 8, wherein each of the plurality of conduits individually connects to a corresponding receiving connector of an outdoor unit, wherein each corresponding receiving connector is a female connector and receives the corresponding fiber optic connector.

10. The connector of claim 1, wherein the housing further comprises an opening in a surface extending from the first end to the second end, the opening being sealable with a lid.

11. The connector of claim 10, wherein one of the opening or the lid is gasketed, such that a gasket seals the lid to the opening during use.

12. The connector of claim 1, wherein the housing is at least partially tapered, such that the first end is smaller than the second end.

13. The connector of claim 1 further comprising internal structures for separating the plurality of conduits between the first end and the second end, such that the internal structures locate each of the plurality of conduits.

14. A connector system comprising:
a first connector having a housing having a first end and a second end, the first end having a face and the second end being substantially open, wherein the face of the first end has an opening in it;
a receiving connector mounted on a circuit board for receiving a plurality of conduits located within the first connector; and
an outdoor unit housing the circuit board having an opening for receiving the plurality of conduits,
wherein the first connector has a gasket at the second end for sealing the first connector against the outdoor unit housing around the opening, and
wherein the plurality of conduits enter the housing at the first end as a single cable and separates into the plurality of conduits within the housing.

15. The connector system of claim 14, wherein the receiving connector comprises a plurality of independent receiving ports, each receiving port configured for receiving a single conduit of the plurality of conduits.

16. The connector system of claim 15, wherein each of the plurality of conduits is a fiber optic fiber terminating in a fiber optic connector.

17. The connector system of claim 15 further comprising a cable gland for sealing the single cable to the opening, such that when the plurality of conduits are received by the plurality of independent receiving ports, the cable gland fixes a location of the housing such that pressure is applied to the gasket against the outdoor unit housing.

18. The connector system of claim 14, wherein the housing further comprises an opening in a surface extending from the first end to the second end, the opening being sealable with a lid.

19. The connector system of claim 14, wherein the housing is at least partially tapered, such that the first end is smaller than the second end.
